(19) United States
(12) Patent Application Publication
(10) Pub. No.: US 2018/0344431 A1
(43) Pub. Date: Dec. 6, 2018

(54) INDIRECT BONDING APPARATUS

(71) Applicant: CHOICE BIOTECH INC., TAINAN CITY (TW)

(72) Inventors: TAI-HONG KUO, TAINAN CITY (TW); TZU-CHIEH WU, TAINAN CITY (TW)

(21) Appl. No.: 15/992,618

(22) Filed: May 30, 2018

(30) Foreign Application Priority Data
Jun. 5, 2017 (TW) 106208000

(51) Int. Cl. A61C 7/14; A61C 7/02; A61C 19/04

(52) U.S. Cl. CPC A61C 7/146; A61C 3/00; A61C 19/04; A61C 7/02

(57) ABSTRACT

An indirect bonding apparatus has a first positioning member and at least one second positioning member. The first positioning member is made by 3D printing after digital planning and has a body and at least one connecting seat disposed on the body. The at least one second positioning member is detachably inserted into the at least one connecting seat of the first positioning member. Each second positioning member has a guiding seat and a positioning frame. The guiding seat is slidably inserted into the at least one connecting seat. The positioning frame is erectly formed on the guiding seat and is adjacent to a front surface of the guiding seat. A positioning groove is formed between the body and the positioning frame of the at least one second positioning member.

This application claims the benefit of Taiwan patent application No. 106208000, filed on Jun. 5, 2017, the entire contents of which are incorporated herein by reference.

### BACKGROUND OF THE INVENTION

### 1. Field of the Invention

The present invention relates to an indirect bonding apparatus, and more particularly to an indirect bonding apparatus that assists in positioning dental braces on teeth.

### 2. Description of Related Art

A conventional indirect bonding apparatus is integrated and assists in positioning dental braces on teeth. The conventional indirect bonding apparatus has a body, a wall, at least one positioning frame, and a positioning groove. The wall and the at least one positioning frame are formed on the body. The positioning groove is formed between the wall and the at least one positioning frame. In use, at least one of the dental braces can be disposed on the at least one positioning frame of the conventional indirect bonding apparatus. A gluing surface of the at least one dental brace is inserted into the positioning groove, and faces the wall of the conventional indirect bonding apparatus. Glue is applied to a user's teeth by an operator, and then the conventional indirect bonding apparatus and the at least one dental brace are disposed on the user's teeth together. The gluing surface of the at least one dental brace is in contact with the glue on the user's teeth for positioning the at least one dental brace. After the at least one dental brace is fixed, the conventional indirect bonding apparatus can be detached from the at least one dental brace and the user's teeth.

However, the conventional indirect bonding apparatus is formed by 3D printing. Sizes and the slanting conditions of the wall and the positioning frame need to be precisely calculated for accurately controlling the position accuracy of the at least one dental brace. In the conventional indirect bonding apparatus, the wall and the at least one positioning frame are integrated with the body. The sizes and the slanting conditions of the wall and the positioning frame are hard to calculate and control. Therefore, the conventional indirect bonding apparatus is difficult to manufacture. In addition, a distance between the gluing surface of the at least one dental brace and the wall is constant in a process for disposing the conventional indirect bonding apparatus on the user's teeth. Space provided by the conventional indirect bonding apparatus is limited and only allows the user's teeth and parts of the glue to pass. When the glue applied to the user's teeth is excessive and the gluing surface of the at least one dental brace passes through the glue, the glue is scraped by the gluing surface of the at least one dental brace and overflows. Shadowing is generated by the positioning frame integrated with the body. The retained glue can not be cleared instantly. The retained glue only can be cleared after the light-curing.

To overcome the shortcomings, the present invention provides a indirect bonding apparatus to mitigate or obviate the aforementioned problems.

### SUMMARY OF THE INVENTION

The objective of the invention is to provide an indirect bonding apparatus to solve the problems that the conventional indirect bonding apparatus is integrated and is complex to manufacture, and the glue on the user's teeth tends to overflow.

The indirect bonding apparatus has a first positioning member and at least one second positioning member. The first positioning member is made by 3D printing after digital planning and has a body and at least one connecting seat. The body has a front surface, a top surface, a bottom surface, and a positioning portion. The positioning portion is formed on the front surface of the body and extends to the top surface of the body.

The at least one connecting seat is disposed on the bottom surface of the body. Each one of the at least one connecting seat has a front surface, a connecting groove, an opening, an inner-bottom surface, and two bearing surfaces. The connecting groove is formed in the at least one connecting seat. The opening is formed on the front surface of the at least one connecting seat and is in communication with the connecting groove. The inner-bottom surface is formed in the at least one connecting seat and is disposed adjacent to the connecting groove. The two bearing surfaces are formed on the inner-bottom surface at a spaced interval.

The at least one second positioning member is detachably inserted into the at least one connecting seat of the first positioning member. Each one of the at least one second positioning member has a guiding seat and a positioning frame. The guiding seat is slidably inserted into the connecting groove and has a front surface and two abutting surfaces. The two abutting surfaces are formed on the guiding seat at a spaced interval and respectively abut the two bearing surfaces of one of the at least one connecting seat. The positioning frame is erectly formed on the guiding seat and is disposed adjacent to the front surface of the guiding seat. A positioning groove is formed between the body and the positioning frame of the at least one second positioning member.

The at least one second positioning member is detachably inserted into the first positioning member. The first positioning member is made by 3D printing after digital planning. Position correctness of each one of the dental braces is adjusted by accuracy of size and angle of the first positioning member. Specifications of the at least one second positioning member inserted into the first positioning member can be standardized for decreasing the manufacture complexity of the indirect bonding apparatus and increasing the accuracy of the indirect bonding apparatus. In use, one of the dental braces is disposed on the positioning frame of one of the at least one second positioning member, and then the guiding seat of said second positioning member is slightly, but not completely, inserted into the connecting groove of one of the at least one connecting seat. Space between the dental brace positioned on the at least one second positioning member and the body of the first positioning member is adequate. In a process of disposing the indirect bonding apparatus on a user's teeth, glue applied to the user's teeth cannot be scraped by the dental brace positioned on the at least one second positioning member. After the indirect bonding apparatus is disposed on the user's teeth, the at least one second positioning member can be pushed and is completely inserted into the at least one connecting seat, and the dental brace positioned on the at least one second positioning member is in contact with the glue on the user's teeth to be fixed in position. Chance of glue overflow is decreased effectively. When the glue is overflowed to form the retained glue, the indirect bonding apparatus is semi-open type for being convenient to remove the almost retained glue before the light-curing.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an indirect bonding apparatus in accordance with the present invention;

FIG. 2 is an exploded perspective view of the indirect bonding apparatus in FIG. 1;

FIG. 3 is a side view in partial section of the indirect bonding apparatus in FIG. 2;

FIG. 4 is a side view of a dentition of a user;

FIG. 5 is an operational side view of the indirect bonding apparatus in FIGS. 3 and 4, showing the glue is applied to the dentition and the indirect bonding apparatus is not disposed yet;

FIG. 6 is an operational side view of the indirect bonding apparatus in FIG. 5, showing a first positioning member of the indirect bonding apparatus is disposed and a second positioning member of the indirect bonding apparatus is not pushed yet; and

FIG. 7 is an operational side view of the indirect bonding apparatus in FIG. 6, showing the second positioning member of the indirect bonding apparatus is pushed.

### DETAILED DESCRIPTION OF THE PREFERRED EMBODIMENT

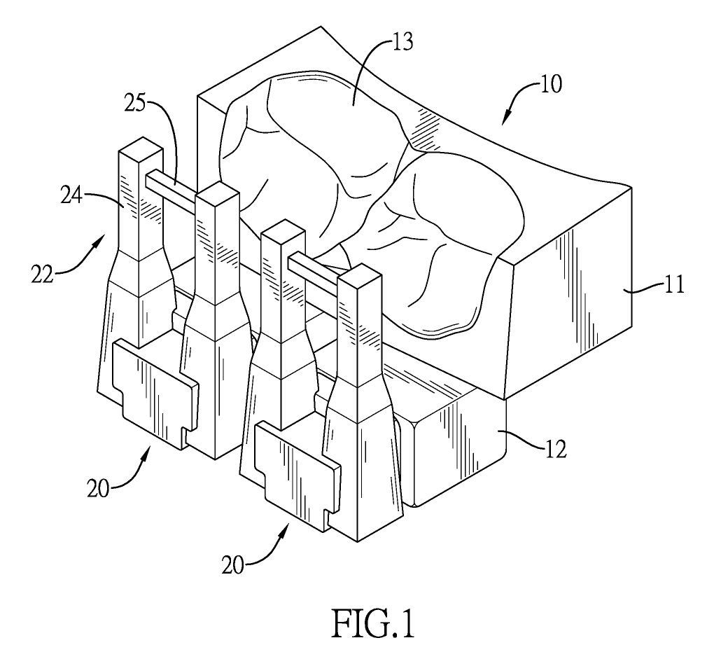

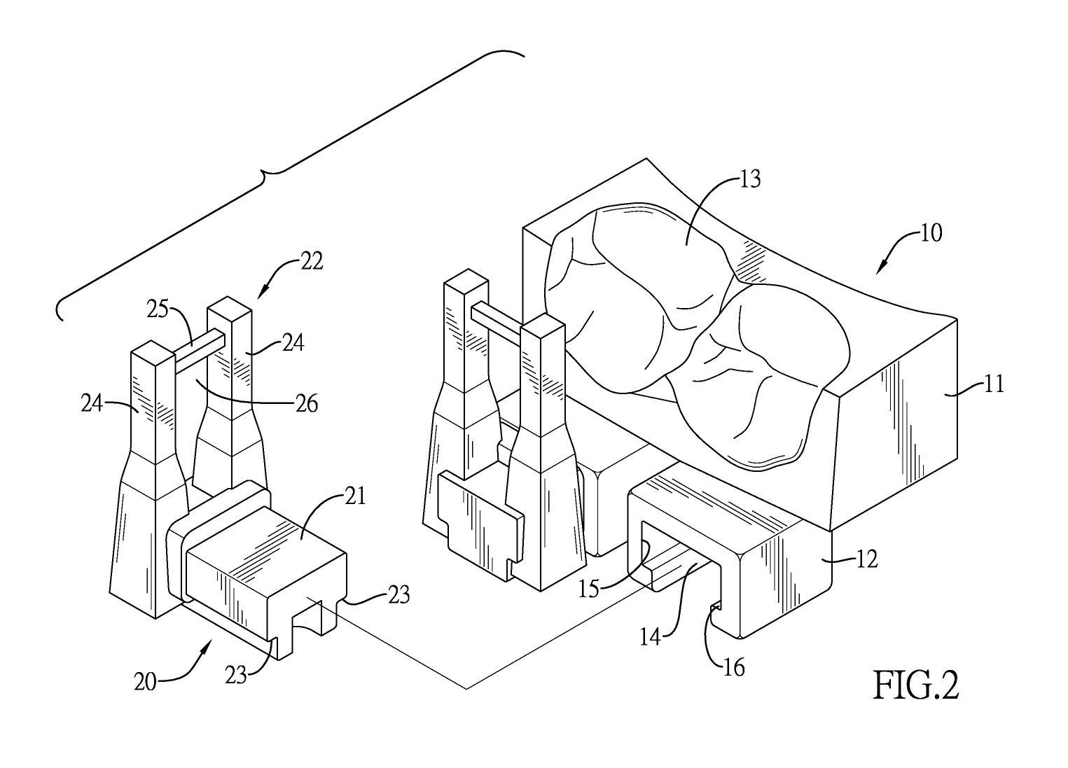

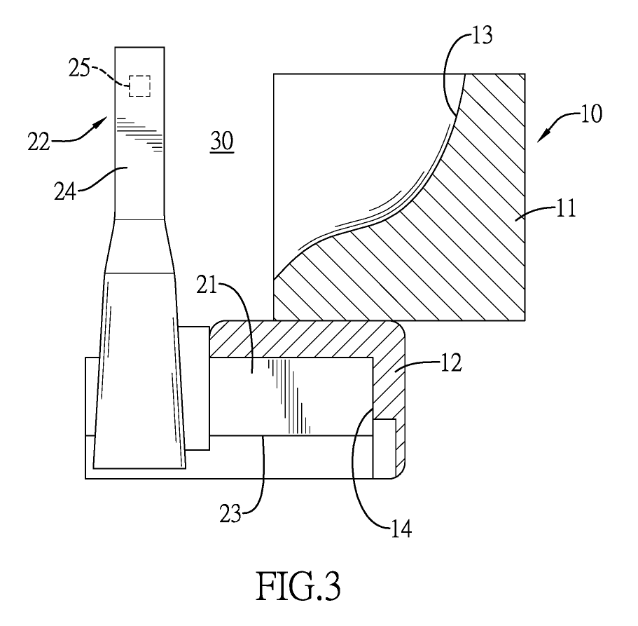

With reference to FIGS. 1 to 3, an indirect bonding apparatus in accordance with the present invention comprises a first positioning member 10 and at least one second positioning member 20.

The first positioning member 10 is made by 3D printing after digital planning and has a body 11 and at least one connecting seat 12. The body 11 has a front surface, a top surface, a bottom surface, and a positioning portion 13. The positioning portion 13 is formed on the front surface of the body 11 and extends to the top surface of the body 11.

The at least one connecting seat 12 is formed on and is disposed below the bottom surface of the body 11. Each one of the at least one connecting seat 12 has a front surface, a connecting groove 14, an opening 15, an inner-bottom surface, and two bearing surfaces 16. The connecting groove 14 is formed in the at least one connecting seat 12. The opening 15 is formed on the front surface of the at least one connecting seat 12 and is in communication with the connecting groove 14. The inner-bottom surface is formed in the at least one connecting seat 12 and is disposed adjacent to the connecting groove 14. The two bearing surfaces 16 are formed on the inner-bottom surface of the at least one connecting seat 12 at a spaced interval.

The at least one second positioning member 20 is detachably inserted into the at least one connecting seat 12 of the first positioning member 10. Each one of the at least one second positioning member 20 has a guiding seat 21 and a positioning frame 22. The guiding seat 21 is slidably inserted into the connecting groove 14 of one of the at least one connecting seat 12. The guiding seat 21 has a front surface and two abutting surfaces 23. The two abutting surfaces 23 are formed on the guiding seat 21 at a spaced interval, and respectively abut the two bearing surfaces 16 of said connecting seat 12. The positioning frame 22 is erectly formed on the guiding seat 21 and is disposed adjacent to the front surface of the guiding seat 21. A positioning groove 30 is formed between the body 11 and the positioning frame 22 of the at least one second positioning member 20.

In each one of the at least one second positioning member 20, the positioning frame 22 has two longitudinal rods 24, a transverse rod 25, and a through hole 26. The two longitudinal rods 24 are formed on the guiding seat 21 at a spaced interval. The transverse rod 25 has two ends respectively connected to the two longitudinal rods 24. The through hole 26 is formed between the two longitudinal rods 24, is formed below the transverse rod 25, and communicates with the positioning groove 30. The at least one second positioning member is dedicated to the self-ligating brackets.

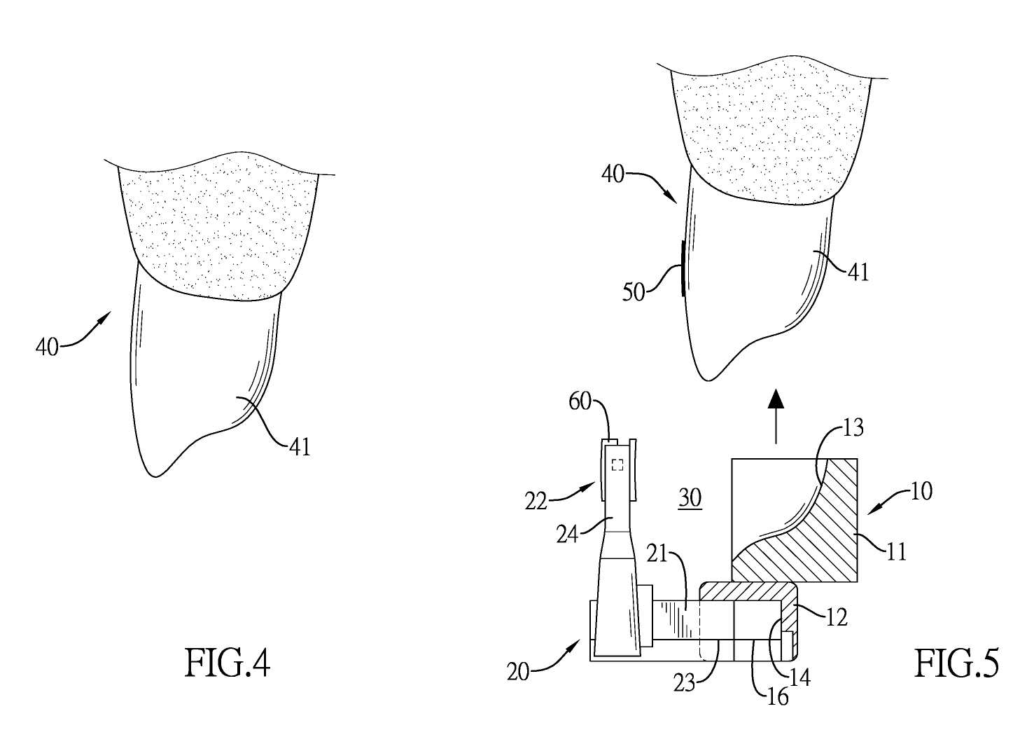

With reference to FIGS. 4 to 7, the indirect bonding apparatus assists in positioning dental braces 60 on teeth 41 of dentition 40 of a user. In use, one of the dental braces 60 is disposed on the transverse rod 25 of the positioning frame 22 of one of the at least one second positioning member 20. The guiding seat 21 of said second positioning member 20 is slightly inserted into the connecting groove 14 of one of the at least one connecting seat 12. Said second positioning member 20 and said dental brace 60 are disposed on the first positioning member 10 together. Glue 50 is applied to the teeth 41 or the inner surfaces of the dental braces 60. The indirect bonding apparatus and the dental braces 60 located on the indirect bonding apparatus are disposed on the teeth 41. The positioning portion 13 of the first positioning member 10 abuts the teeth 41 for positioning the indirect bonding apparatus on the teeth 41 of the dentition 40. Before the first positioning member 10 is disposed on the teeth 41, the guiding seat 21 of said second positioning member 20 is partially inserted into the connecting groove 14 of said connecting seat 12. Space between the positioning frame 22 of said second positioning member 20 and the body 11 of the first positioning member 10 is adequate. When the indirect bonding apparatus passes through the teeth 41, the glue 50 applied to the teeth 41 cannot be in contact with and scraped by the dental braces 60.

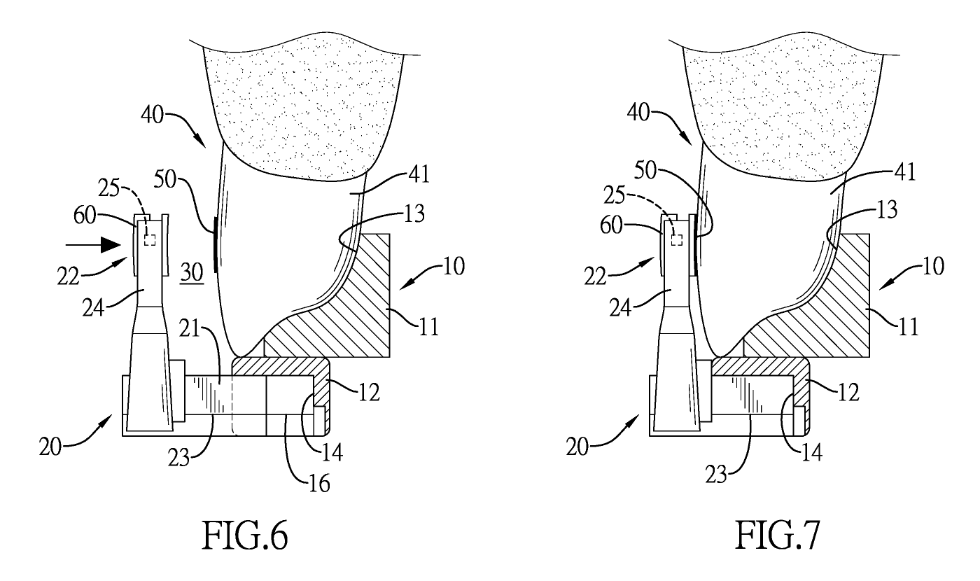

With reference to FIGS. 6 and 7, after the positioning portion 13 is disposed on the teeth 41, the guiding seat 21 of said second positioning member 20 can be pushed, and said dental brace 60 on the guiding seat 21 moves toward a corresponding one of the teeth 41 and is in contact with the glue 50 on the corresponding tooth 41. Said dental brace 60 is fixed on the corresponding tooth 41 by the glue 50. The indirect bonding apparatus can be detached from the teeth 41 after fixing the dental braces 60.

Accordingly, the at least one second positioning member 20 is detachably inserted into the first positioning member 10. The first positioning member 10 is made by 3D printing after digital planning. The first positioning member 10 and the at least one second positioning member 20 are manufactured separately. Structure of the first positioning member 10 is simplified for decreasing the manufacture complexity of the indirect bonding apparatus and increasing the accuracy of the indirect bonding apparatus. The at least one second positioning member 20 is inserted into the first positioning member 10. Position and angle of the at least one second positioning member 20 depend on the first positioning member 10. The dental braces 60 are disposed on the at least one second positioning member 20, and the at least one second positioning member 20 is inserted to the first positioning member 10. Therefore, accuracy of the dental braces 60 disposed on the teeth 41 is increased by the first positioning member 10 having good accuracy. The accuracy of the dental braces 60 disposed on the teeth 41 depends on the first positioning member 10. Thus, specifications of the at least one second positioning member 20 can be standardized for ease and convenience in manufacture.

In addition, the at least one second positioning member 20 is detachably inserted into the first positioning member 10. A distance between the dental braces 60 and the positioning portion 13 can be adjusted by the at least one second positioning member 20. In a process of disposing the indirect bonding apparatus on the teeth 41 of the dentition 40, space between the positioning frame 22 of the at least one second positioning member 20 and the body 11 of the first positioning member 10 is adequate. The glue 50 applied to the teeth 41 cannot be scraped by the dental braces 60 positioned on the at least one second positioning member 20. After the first positioning member 10 is positioned, the at least one second positioning member 20 can be pushed and moves. The dental braces 60 positioned on the at least one second positioning member 20 are in contact with the glue 50 on the teeth 41 to be fixed in position. Chances of overflow of the glue 50 are reduced effectively.

What is claimed is:

1. An indirect bonding apparatus comprising:
a first positioning member being made by 3D printing after digital planning, and having
a body having
a front surface;
a top surface;
a bottom surface; and
a positioning portion formed on the front surface of the body and extending to the top surface of the body; and
at least one connecting seat disposed on the bottom surface of the body, and each one of the at least one connecting seat having
a front surface;
a connecting groove formed in the at least one connecting seat;
an opening formed on the front surface of the at least one connecting seat and communicating with the connecting groove;
an inner-bottom surface formed in the at least one connecting seat and disposed adjacent to the connecting groove; and
two bearing surfaces formed on the inner-bottom surface at a spaced interval; and
at least one second positioning member detachably inserted into the at least one connecting seat of the first positioning member, and each one of the at least one second positioning member having
a guiding seat slidably inserted into the connecting groove of one of the at least one connecting seat, and having
a front surface; and
two abutting surfaces formed on the guiding seat at a spaced interval and respectively abutting the two bearing surfaces of one of the at least one connecting seat; and
a positioning frame erectly formed on the guiding seat and disposed adjacent to the front surface of the guiding seat;
wherein a positioning groove is formed between the body and the positioning frame of the at least one second positioning member.

2. The indirect bonding apparatus as claimed in claim 1, wherein in each one of the at least one second positioning member, the positioning frame has
two longitudinal rods formed on the guiding seat at a spaced interval;
a transverse rod having two ends respectively connected to the two longitudinal rods;
a through hole formed between the two longitudinal rods, formed below the transverse rod, and communicating with the positioning groove; and
wherein the at least one second positioning member is dedicated to the self-ligating brackets
